(19) United States
(12) Patent Application Publication
(10) Pub. No.: US 2026/0188907 A1
(43) Pub. Date: Jul. 2, 2026

(54) DUAL FREQUENCY BAND RADIATOR MODULE

(71) Applicant: POSTECH RESEARCH AND BUSINESS DEVELOPMENT FOUNDATION, Pohang-si (KR)

(72) Inventors: Won Bin HONG, Seoul (KR); Jeong Hyo LEE, Pohang-si (KR)

(73) Assignee: POSTECH RESEARCH AND BUSINESS DEVELOPMENT FOUNDATION, Pohang-si (KR)

(21) Appl. No.: 19/326,282

(22) Filed: Sep. 11, 2025

(30) Foreign Application Priority Data
Dec. 30, 2024 (KR) 10-2024-0200670

(51) Int. Cl. H01Q 9/04; H01Q 5/35

(52) U.S. Cl. CPC H01Q 9/0464; H01Q 5/35; H01Q 9/0414

(57) ABSTRACT

Provided is a dual frequency band radiator module. The radiator module includes a ground layer, a circular patch radiator disposed on the ground layer so as to be spaced apart from the ground layer by a predetermined length, a via-wall composed of a plurality of vertical probes extending from the ground layer to an area surrounding the circular patch radiator, and a port disposed between the ground layer and the circular patch radiator. The radiator module radiates a signal in a first frequency band based on the via-wall, and radiates a signal in a second frequency band different from the first frequency band based on the via-wall and the circular patch radiator.

### CROSS-REFERENCE TO RELATED APPLICATION

This application claims the benefit of and priority to Korean Patent Application No. 10-2024-0200670, filed on Dec. 30, 2024, the entire disclosure(s) of which is hereby incorporated herein by reference in its entirety.

### TECHNICAL FIELD

The present disclosure relates to wireless communication, and more specifically, to a dual frequency band radiator module capable of implementing a multi-band and wideband phased array antenna even in a twice or greater frequency spacing based on a single layer using multiple higher-order modes.

### BACKGROUND

Wireless communication technologies for transmitting and receiving information are continuously developing. Among them, an antenna device is required to transmit or receive a signal for wireless communication, and antenna devices in various forms and of various types have been developed to achieve higher performance. Recently, technologies, such as an MIMO antenna, have been developed to overcome performance limitations that are difficult to surpass with a single antenna. Additionally, a beamforming technology for controlling radiation directions of signals to maximize a strength of the signals transmitted and received between a base station and a terminal has been developed.

In particular, to implement high-speed data transfer rate and low latency communication, recent wireless communication technologies such as, for example, 3GPP 5G or 6G have begun to use frequency in a millimeter wave (mmWave) band, even in a terahertz (THz) band. In a millimeter wave band wireless channel environment, a beamforming technology using a phased array antenna is being applied more importantly to solve a problem that signal attenuation may occur because of characteristics of free space path loss and diffraction reduction. Such a beamforming technology is required at both the base station and the terminal, and in particular, it is essential to secure wide coverage and overcome radio wave loss in a mobile wireless channel environment.

In one example, initial millimeter wave band utilization was made for a specific frequency band such as, for example, a 28 GHz band, but attempts are gradually being made to utilize various frequency bands, such as a 43 GHz band. That is, as various types of mmWave communication are developed, the frequency bands used are diversified and expanded. Because the millimeter wave frequency bands used may be different for respective uses and countries, it is a question whether a plurality of antenna devices should be equipped to transmit and receive signals corresponding to the various millimeter wave frequency bands.

In particular, to perform beamforming, it is required to adjust a spacing between respective radiators of an antenna array based on a frequency band of a signal to be radiated. When the radiators are arranged in the antenna array at a spacing that does not match the frequency band of the signal to be radiated, high mutual coupling and grating lobe problems may occur.

Therefore, to perform beamforming on signals in a plurality of frequency bands, a method of including antenna devices including radiator arrays corresponding to the respective frequency bands may be considered. However, in particular, in a mobile device, because an area that may be utilized for mounting the antenna, such as a bezel area, is gradually reduced, an importance of design for multiple and broadband antennas is emerging.

### SUMMARY

An object of the present disclosure for solving the above-described problems is to provide a dual harmonic radiator module using a dual function radiator capable of implementing a complete phased array antenna even for dual harmonic frequencies having a twice or greater frequency spacing based on a circular patch antenna and a circular via-wall surrounding the circular patch antenna.

Another object of the present disclosure for solving the above-described problems is to provide a radiator array capable of implementing a complete phased array antenna even for dual harmonic frequencies having a twice or greater frequency spacing based on a circular patch antenna and a circular via-wall surrounding the circular patch antenna.

However, the objects of the present disclosure may not be limited thereto, and may be variously expanded within a range not departing from the spirit and scope of the present disclosure.

An aspect of the present disclosure provides a dual frequency band radiator module including a ground layer, a circular patch radiator disposed on the ground layer so as to be spaced apart from the ground layer by a predetermined length, a via-wall composed of a plurality of vertical probes extending from the ground layer to an area surrounding the circular patch radiator, and a port disposed between the ground layer and the circular patch radiator, wherein a signal in a first frequency band is radiated based on the via-wall, wherein a signal in a second frequency band different from the first frequency band is radiated based on the via-wall and the circular patch radiator.

In one implementation, the first frequency band may cover a first frequency, and the second frequency band may cover a second frequency, wherein the second frequency is n times the first frequency, and n is a natural number equal to or greater than 2.

In one implementation, the signal in the first frequency band may be radiated via resonance in a first mode of the via-wall.

In one implementation, the first mode resonance of the via-wall may radiate a signal in a frequency band lower than a frequency band of a signal radiated based on resonance in a first mode of the circular patch radiator.

In one implementation, the via-wall may form a perfect magnetic conductor (PMC) boundary different from a state of the circular patch radiator disposed without the via-wall.

In one implementation, a signal via resonance in a second mode of the via-wall and a signal via resonance in a third mode of the circular patch radiator may be synthesized to radiate the signal in the second frequency band.

In one implementation, at least a portion of current flows formed by the via-wall and at least a portion of current flows formed by the circular patch radiator may cancel each other.

In one implementation, at least the portion of the current flows formed by the circular patch radiator may form residual current flows, and the signal in the second frequency band may be radiated by the residual current flows.

In one implementation, the first mode may be a TM11 mode, the second mode may be a TM12 mode, and the third mode may be a TM10 mode.

In one implementation, a first frequency may be 24 GHz, and a second frequency may be 48 GHz.

Another aspect of the present disclosure provides an antenna device including a dual frequency band radiator array including the radiator array including a plurality of radiator modules, and a control circuit that applies signals to the plurality of radiator modules, wherein each of the plurality of radiator modules includes a ground layer, a circular patch radiator disposed on the ground layer so as to be spaced apart from the ground layer by a predetermined length, a via-wall composed of a plurality of vertical probes extending from the ground layer to an area surrounding the circular patch radiator, and a port disposed between the ground layer and the circular patch radiator, wherein a signal in a first frequency band is radiated based on the via-wall, wherein a signal in a second frequency band different from the first frequency band is radiated based on the via-wall and the circular patch radiator. Further, the control circuit performs beamforming for the signal in the first frequency band and beamforming for the signal in the second frequency band.

In one implementation, the plurality of radiator modules may be arranged at an array spacing for performing beamforming for the signal in the second frequency band.

In one implementation, the control circuit may perform beamforming for the signal in the second frequency band based on at least some radiator modules consecutively arranged among radiator modules excluding radiator modules disposed at outermost sides of the radiator array, among the plurality of radiator modules.

In one implementation, the control circuit may perform beamforming for the signal in the first frequency band based on two radiator modules disposed at outermost sides of the radiator array, and at least some radiator modules not consecutively arranged among radiator modules excluding the radiator modules disposed at the outermost sides of the radiator array, among the plurality of radiator modules.

In one implementation, at least some of the plurality of radiator modules may be used to radiate the signal in the first frequency band and the signal in the second frequency band.

In one implementation, at least some of the plurality of radiator modules may be configured not to radiate any of the signal in the first frequency band and the signal in the second frequency band.

In one implementation, at least some of radiator modules not used to radiate the signal in the first frequency band among the plurality of radiator modules may further include a first shorting pin connecting the ground layer with the circular patch radiator in a null area based on an electric field distribution associated with the signal radiation in the second frequency band.

In one implementation, the first shorting pin may cause impedance mismatching on the signal in the first frequency band, and not have an influence on the signal in the second frequency band.

In one implementation, at least some of radiator modules not used to radiate the signal in the second frequency band among the plurality of radiator modules may further include a second shorting pin connecting the ground layer with the circular patch radiator in a null area based on an electric field distribution associated with the signal radiation in the first frequency band.

In one implementation, the second shorting pin may cause impedance mismatching on the signal in the second frequency band, and not have an influence on the signal in the first frequency band.

In one implementation, the antenna device may further include a plurality of feeding ports, wherein the number of feeding ports is smaller than the number of plurality of radiator modules.

In one implementation, at least some of the plurality of feeding ports may supply feed signals to multiple radiator modules, and others of the plurality of feeding ports may supply the feed signal to only one radiator module.

The disclosed technology may have following effects. However, because it does not mean that a specific embodiment should include all of the following effects or only the following effects, it should not be understood that the scope of the rights of the disclosed technology is limited thereto.

According to the above-described dual frequency band radiator module according to an embodiment of the present disclosure, the complete phased array antenna may be implemented even for the dual harmonic frequencies having the twice or greater frequency spacing based on the circular patch antenna and the circular via-wall surrounding the circular patch antenna.

That is, the phased array antenna capable of respectively operating for the plurality of frequency bands having the twice or greater spacing may be designed in the single layer, thereby securing cost and space design efficiencies while performing beamforming for the multiple bands. That is, the multi-band beamforming antenna for the harmonic frequencies may be implemented in a narrow space.

### BRIEF DESCRIPTION OF THE DRAWINGS

FIG. 1 is a perspective view of a dual frequency band radiator module according to an embodiment of the present disclosure.

FIG. 2 is a top view of a dual frequency band radiator module in FIG. 1.

FIG. 3 illustrates radiation characteristics of a first frequency band and a second frequency band based on a dual frequency band radiator module in FIG. 1.

FIG. 4 illustrates a frequency change of a radiation signal depending on presence of a via-wall.

FIG. 5 illustrates current flows based on a via-wall and a circular patch radiator.

FIG. 6 illustrates an electric field distribution based on current flows in FIG. 5.

FIG. 7 illustrates radiation patterns in a first frequency band and a second frequency band of a dual frequency band radiator module according to an aspect.

FIG. 8 is a perspective view of an antenna device including a dual frequency band radiator array according to an embodiment of the present disclosure.

FIG. 9 is a top view of an antenna device including a dual frequency band radiator array in FIG. 8.

FIG. 10 illustrates a radiator module that radiates a signal in a first frequency band in an antenna device in FIG. 8.

FIG. 11 illustrates a radiator module that radiates a signal in a second frequency band in an antenna device in FIG. 8.

FIG. 12 illustrates an improvement in a radiation performance of a signal in a first frequency band based on a presence of a shorting pin.

FIG. 13 illustrates an improvement in a radiation performance of a signal in a second frequency band based on a presence of a shorting pin.

FIG. 14 illustrates radiation patterns in a first frequency band and a second frequency band based on an antenna device including a dual frequency band radiator array according to an embodiment of the present disclosure.

FIG. 15 illustrates a beamforming performance at a first frequency based on an antenna device including a dual frequency band radiator array according to an embodiment of the present disclosure.

FIG. 16 illustrates a beamforming performance at a first frequency based on an antenna device including a dual frequency band radiator array according to an embodiment of the present disclosure.

### DETAILED DESCRIPTION

Because the present disclosure may be variously changed and have various embodiments, specific embodiments will be illustrated in the drawings and described in detail.

However, this is not intended to limit the present disclosure to the specific embodiments, and it should be understood that the present disclosure includes all changes, equivalents, and substitutes included in the spirit and technical scope of the present disclosure.

Terms such as first, second, and the like may be used to describe various components, but the components should not be limited by the terms. The terms are used only for the purpose of distinguishing one component from another component. For example, without departing from the scope of the present disclosure, a first component may be referred to as a second component, and similarly, a second component may also be referred to as a first component. The term and/or includes a combination of a plurality of related described items or any of the plurality of related described items.

When it is mentioned that a component is “connected” or “coupled” to another component, it should be understood that the component may be directly connected or coupled to said another component, but a further component may exist therebetween. On the other hand, when it is mentioned that a component is “directly connected” or “directly coupled” to another component, it should be understood that the further component does not exist therebetween.

The terms used herein are used only to describe the specific embodiments and are not intended to limit the present disclosure. A singular expression includes a plural expression, unless the context clearly dictates otherwise. In the present application, terms such as “include” or “have” are intended to designate that features, numbers, steps, operations, components, parts, or combinations thereof described herein exist, and it should be understood that the possibility of the presence or addition of one or more other features, numbers, steps, operations, components, parts, or combinations thereof is not excluded in advance.

Unless otherwise defined, all terms used herein, including technical or scientific terms, have the same meanings as those generally understood by those of ordinary skill in the art to which the present disclosure pertains. Terms such as those defined in commonly used dictionaries should be interpreted as having meanings consistent with contextual meanings of the related art, and are not interpreted in an ideal or excessively formal sense unless explicitly defined in the present application.

Hereinafter, preferred embodiments of the present disclosure will be described in more detail with reference to the accompanying drawings. In the description of the present disclosure, to facilitate overall understanding, the same reference numerals are used for the same components in the drawings, and redundant descriptions of the same components will be omitted.

### Overview

An antenna device is required to transmit or receive a signal for wireless communication. To achieve higher performance, antenna devices in various forms and of various types have been developed, and a beamforming technology for controlling radiation directions of signals has been widely used to maximize a strength of the signals transmitted/received between a base station and a terminal. In particular, recent wireless communication technologies, such as, for example, 3GPP 5G, have begun to use frequency in a millimeter wave (mmWave) band. To implement high-speed data transfer rate and low latency wireless communication, use of mmWave wireless communication is considered essential.

In a millimeter wave band wireless channel environment, a beamforming technology using a phased array antenna is being applied more importantly to solve a problem that signal attenuation may occur because of characteristics of free space path loss and diffraction reduction. Such a beamforming technology is required at both the base station and the terminal, and in particular, it is essential to secure high gain and wide coverage and overcome radio wave loss in a mobile wireless channel environment.

In general, it is known that, to perform beamforming without generation of a grating lobe using a radiator array, it is preferable to arrange a plurality of radiators constituting the phased array antenna to have a spacing of approximately half wavelength, more specifically, in a range of 0.4 to 0.6λ. Because an antenna spacing not suitable for an operating frequency band causes problems of high mutual coupling of the plurality of radiators and the generation of the grating lobe, implementation of a multi-band and wideband phased array antenna has a very large engineering challenge. However, considering flexibility of communication utilization and a shrinking antenna area within a mobile device, a development of the multi-band and wideband phased array antenna is essential. That is, mmWave usable frequency bands are expanding because of emergence of various types of wireless communication, and the development of the multi-band and wideband mmWave antennas is required because of the reduction of the antenna area in the mobile device.

However, as described above, in implementing the phased array antenna operable for multiple and diverse frequencies, there are problems such as the generation of the grating lobe, beam tilt, the high mutual coupling, and the like, and in particular, such problems are maximized in a twice or greater frequency spacing. For example, a signal of a second frequency that is twice the frequency of the first frequency signal may be referred to as a harmonic. For example, when it is assumed that a spacing between the radiator arrays is set based on half wavelength of the first frequency, the radiator arrays may be arranged at a spacing of one wavelength with respect to the second frequency. When the radiator arrays are arranged at one wavelength spacing of the corresponding frequency as such, when considering the principle of overlap, overlap may occur at a plurality of locations, and thus severe grating lobe generation may be experienced. Therefore, not only is a gain decreased, but an accuracy of beamforming is also inevitably reduced.

In the related art, there is no case of implementing a complete phased array antenna at dual-harmonic frequencies, and methods proposed to overcome this have inevitably a large and complex structure.

In this regard, for utilization in devices including the terminal, coupling of the phased array antenna and an RFIC is essential, and an importance of an Antenna-in-Package (AiP) implementing the same has emerged. To efficiently mount the AiP in the terminal, a low profile antenna structure is preferred. In achieving the low profile, implementation of an antenna using only a single layer may be very valuable. Accordingly, implementation of a multi-band phased array antenna using only the single layer antenna may have a very large ripple effect in the mmWave wireless communication.

The present disclosure is to solve the above-described problems. A dual frequency band radiator module according to an embodiment of the present disclosure may implement the complete phased array antenna for the dual-harmonic frequencies in a single space and the single layer based on a circular patch antenna and a circular via-wall surrounding the circular patch antenna, and may enable utilization thereof even in the mobile device via a compact structure.

### Dual Frequency Band Radiator Module

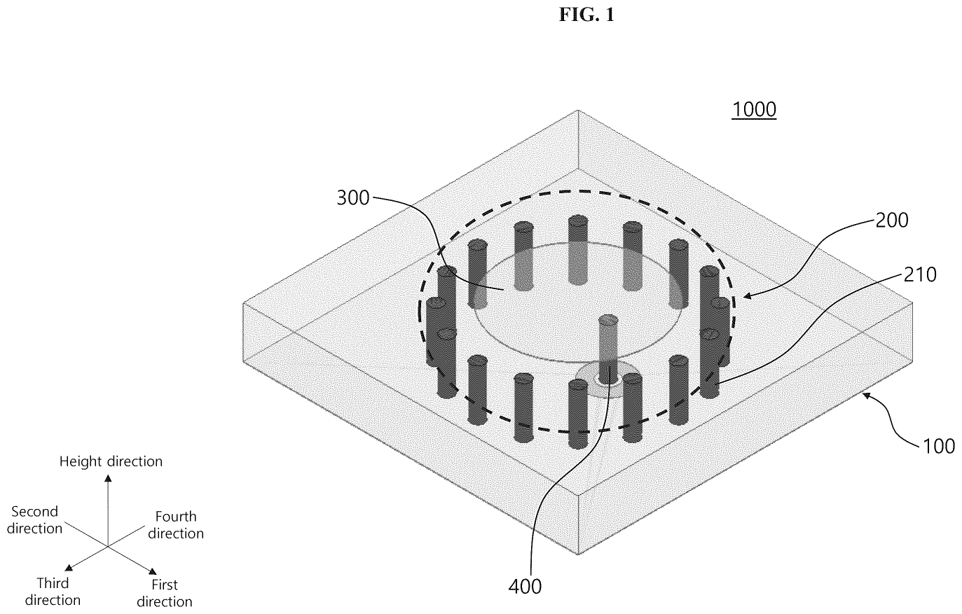

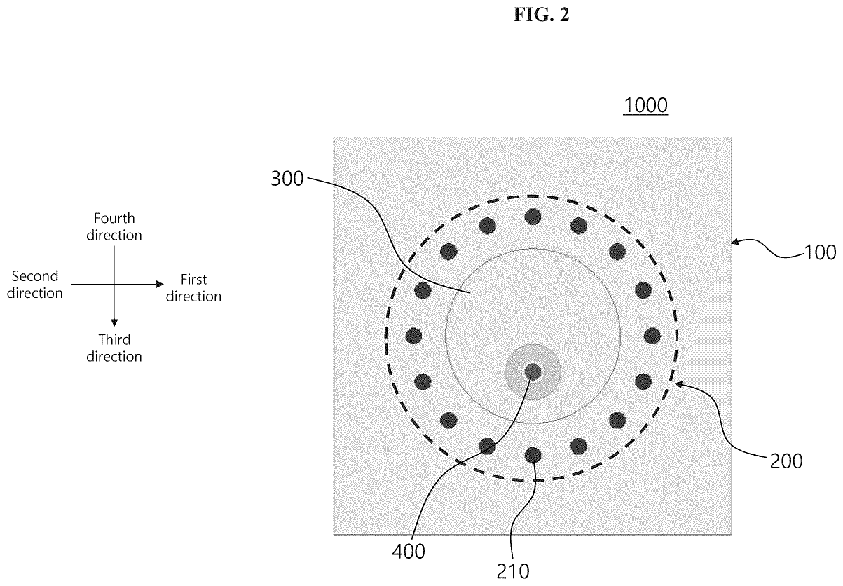

FIG. 1 is a perspective view of a dual frequency band radiator module according to an embodiment of the present disclosure, and FIG. 2 is a top view of a dual frequency band radiator module in FIG. 1. Hereinafter, the dual frequency band radiator module according to an embodiment of the present disclosure will be described in detail without being limited thereto.

As illustrated in FIGS. 1 and 2, a dual frequency band radiator module 1000 according to an embodiment of the present disclosure may include a ground layer 100, a circular patch radiator 300, a via-wall 200, and a port 400.

In a non-limiting yet more detailed manner, as illustrated in FIGS. 1 and 2, according to the dual frequency band radiator module 1000 according to an embodiment of the present disclosure, the ground layer 100 may be disposed, and the circular patch radiator 300 may be disposed on the ground layer 100 so as to be spaced apart from the ground layer 100 by a predetermined length. From the ground layer 100 to at least a portion of an area (e.g., a circular area) surrounding the circular patch radiator 300, a plurality of vertical probes 210 may extend to constitute the via-wall 200. The port 400 may be disposed between the ground layer 100 and the circular patch radiator 300 and provide an electrical connection between the ground layer 100 and the circular patch radiator 300.

According to an aspect, the dual frequency band radiator module 1000 may radiate a signal of a first frequency band based on the via-wall 200, and radiate a signal of a second frequency band different from the first frequency band based on the via-wall 200 and the circular patch radiator 300.

In other words, as a non-limiting example, the dual frequency band radiator module 1000 according to an aspect may be configured with the circular patch radiator 300 and the circular via-wall 200, and may radiate a signal via TM11 mode resonance of the circular via-wall 200 at 24 GHz, and radiate a signal by synthesizing TM12 mode resonance of the circular via-wall 200 and TM10 mode resonance of the circular patch radiator 300 at 48 GHz.

Hereinafter, for convenience of description, a “first mode” may be a “TM11 mode”, a “second mode” may be a “TM12 mode”, and a “third mode” may be a “TM10 mode”, but these are merely an example and the technical idea of the present disclosure is not limited thereto.

In one example, according to an aspect, the first frequency band may include a first frequency, and the second frequency band may include a second frequency that is a frequency n times the first frequency, where n is a natural number equal to or greater than two. That is, the dual frequency band radiator module 1000 according to an embodiment of the present disclosure may implement beamforming based on one radiator array even for the dual harmonic frequencies having a frequency spacing equal to or greater than twice the fundamental frequency.

In this regard, the first frequency may be 24 GHz and the second frequency may be 48 GHz, but it should be noted that the technical spirit of the present disclosure is not limited thereto.

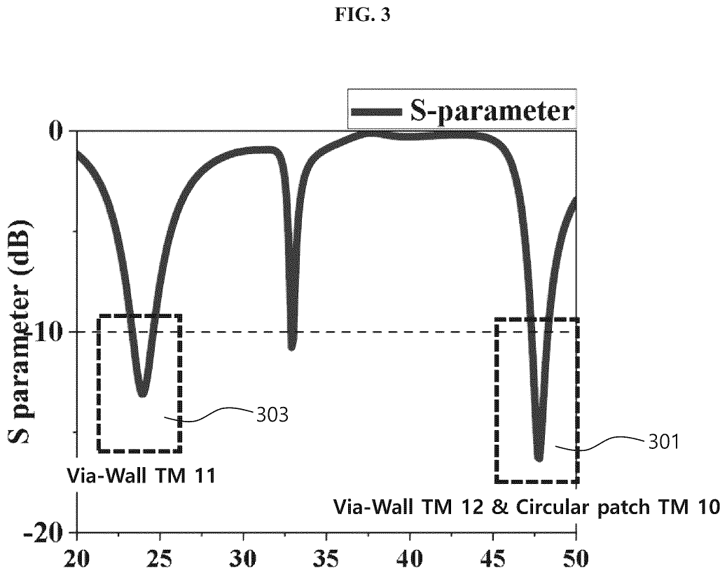

FIG. 3 illustrates radiation characteristics of a first frequency band and a second frequency band based on a dual frequency band radiator module in FIG. 1. As illustrated in FIG. 3, based on the dual frequency band radiator module 1000 according to an embodiment of the present disclosure, it was identified that both a first frequency band 303 and a second frequency band 301 have good radiation characteristics.

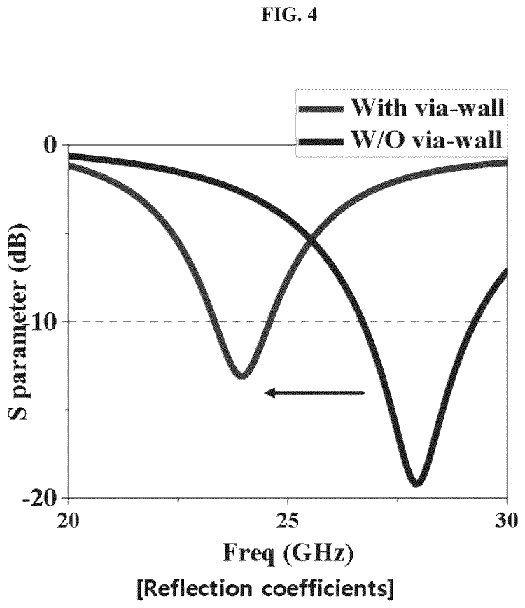

FIG. 4 illustrates a frequency change of a radiation signal depending on presence of a via-wall. In this regard, according to an aspect of the present disclosure, the dual frequency band radiator module 1000 according to an embodiment of the present disclosure may radiate the signal of the first frequency band via first mode resonance of the via-wall 200. Here, the first mode resonance of the via-wall 200 may radiate a signal in a frequency band lower than a frequency band of a signal radiated based on first mode resonance of the circular patch radiator 300. In this regard, the via-wall 200 may form a perfect magnetic conductor (PMC) boundary that is different from a state in which the circular patch radiator 300 is disposed without the presence of the via-wall.

In a non-limiting yet more detailed manner, for example, when TM11 mode resonance, which is a basic resonance mode of the circular patch radiator 300, is performed, broadside radiation in the 28 GHz band may be performed. Here, when the circular via-wall 200 is implemented around the circular patch radiator 300 in addition to the circular patch radiator 300, the new perfect magnetic conductor (PMC) boundary may be formed compared to the case in which the via-wall 200 is not present. For example, the new PMC boundary condition may be induced via the circular via-wall 200 to extend an electrical length, and an operating frequency may be induced to be lowered via the extension of the electrical length. Accordingly, because of the TM11 mode resonance, which is the basic resonance mode of the circular via-wall 200, the broadside radiation in a 24 GHz band, which is a reduced frequency compared to 28 GHz, may be performed. That is, as illustrated in FIG. 4, a resonant frequency may be lower when the via-wall 200 is present than when the via-wall 200 is not present. Accordingly, the dual frequency band radiator module 1000 according to an embodiment of the present disclosure may radiate the signal of the first frequency band (e.g., 24 GHz).

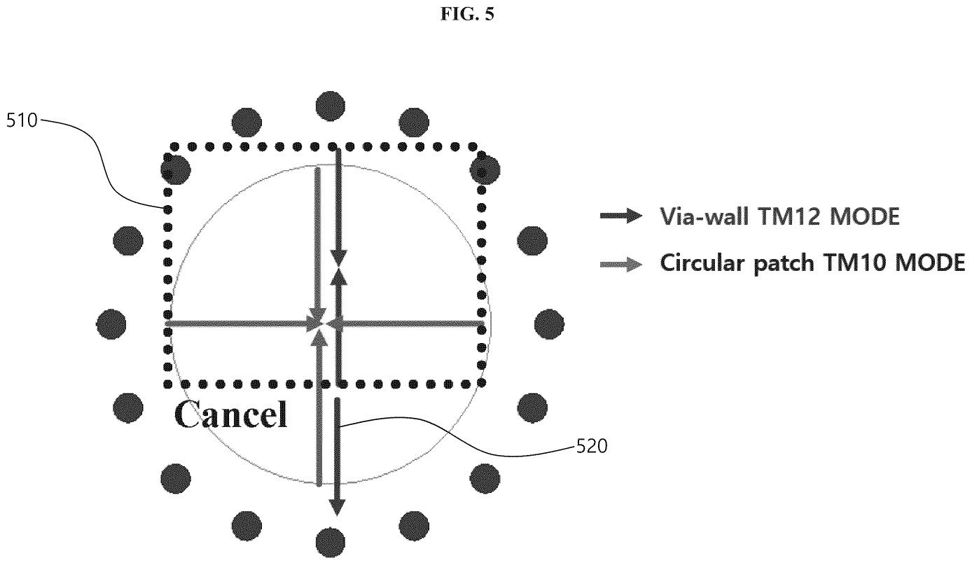

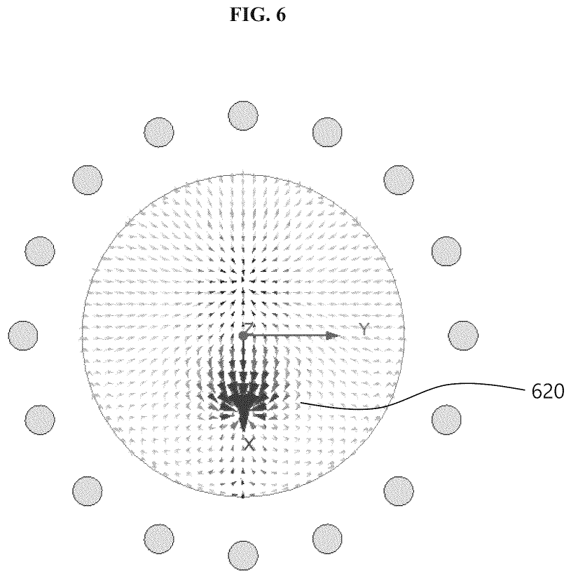

FIG. 5 illustrates current flows based on a via-wall and a circular patch radiator, and FIG. 6 illustrates an electric field distribution based on current flows in FIG. 5. As exemplarily illustrated in FIGS. 5 to 6, as a non-limiting example, the broadside radiation in the 48 GHz frequency band may be performed by the synthesized radiation of the TM12 mode resonance of the circular via-wall 200 and the TM10 mode resonance of the circular patch radiator 300, but the present disclosure may not be limited thereto. For example, currents may be synthesized and canceled as illustrated in FIG. 5 to implement the broadside radiation at 48 GHz by matching a TM12 mode resonant frequency of the circular via-wall 200 with a TM10 mode resonant frequency of the circular patch radiator 300.

According to an aspect, the signal via the second mode resonance of the via-wall 200 and a signal via third mode resonance of the circular patch radiator 300 may be synthesized to radiate the signal in the second frequency band. Here, the second mode may be the TM12 mode, and the third mode may be the TM10 mode, but the present disclosure may not be limited thereto.

As illustrated in FIG. 5, at least a portion of current flows formed by the via-wall 200 and at least a portion of current flows formed by the circular patch radiator 300 may cancel 510 each other. In this regard, the current flows by the circular patch radiator 300 may cancel each other and at least a portion of the current flows by the via-wall 200 may cancel each other, but the present disclosure may not be limited thereto, and a portion of the current flows by the circular patch radiator 300 and a portion of the current flows by the via-wall 200 may cancel each other.

In this regard, referring again to FIG. 5, at least a portion of the current flows formed by the circular patch radiator 300 may form residual current flows 520. That is, at least the portion of the current flows formed by the via-wall 200 and at least the portion of the current flows formed by the circular patch radiator 300 may cancel 510 each other, and only at least the portion of the current flows formed by the circular patch radiator 300 may remain. Here, the signal in the second frequency band may be radiated by the residual current flows 520. For example, as illustrated in FIG. 6, an electric field distribution 620 may be formed by the residual current flows 520, and accordingly, the signal of the second frequency band may be radiated.

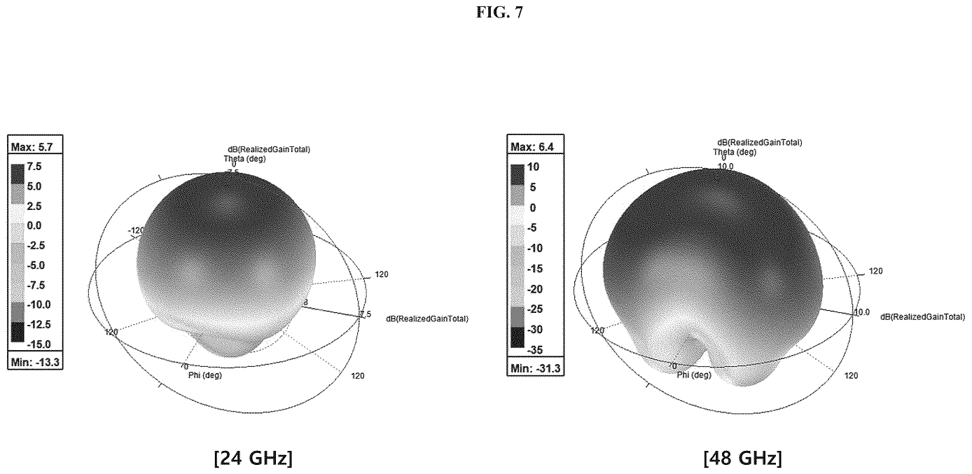

FIG. 7 illustrates radiation patterns in a first frequency band and a second frequency band of a dual frequency band radiator module according to an aspect. As illustrated in FIG. 7, the dual frequency band radiator module 1000 according to an embodiment of the present disclosure may perform the broadside radiation in both the first frequency band (e.g., the 24 GHz band) and the second frequency band (e.g., the 48 GHz band). According to an aspect, the broadside radiation may be implemented simultaneously at the dual harmonic frequencies via the TM11 mode resonance (in the 24 GHz band) of the circular via-wall 200 and synthesized multi-higher-order mode resonance (in the 48 GHz band).

As described above, according to an aspect, the first mode may be the TM11 mode, the second mode may be the TM12 mode, and the third mode may be the TM10 mode, but the present disclosure may not be limited thereto. Further, the first frequency may be 24 GHz and the second frequency may be 48 GHz, but the present disclosure may not be limited thereto.

### Dual Frequency Band Antenna Device

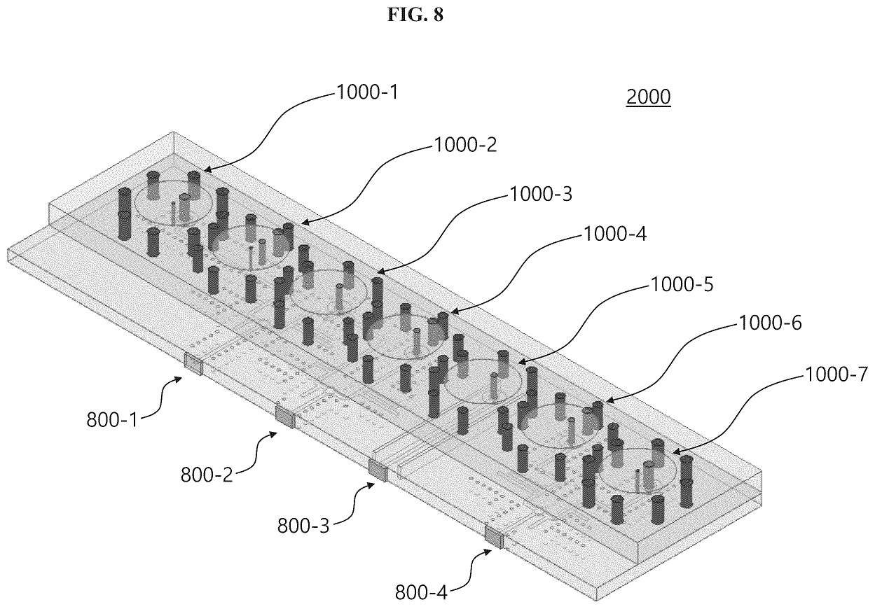

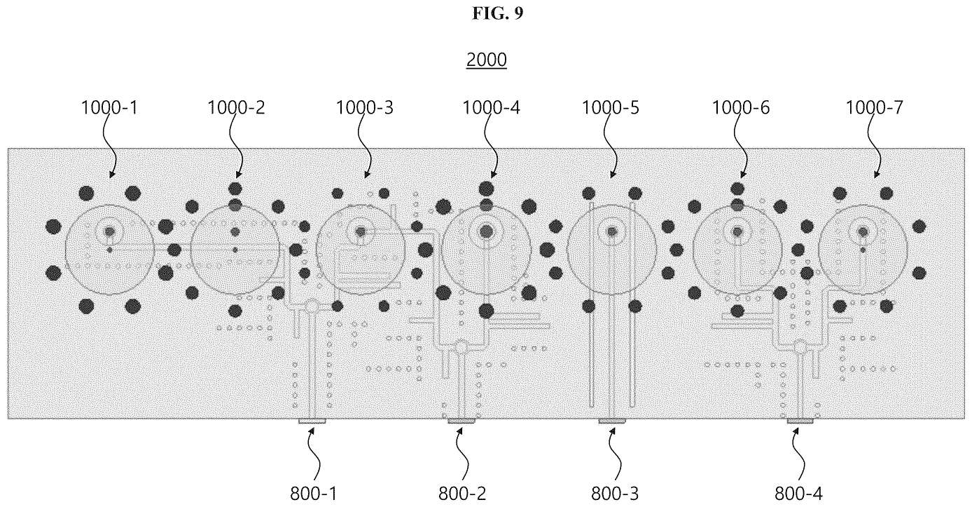

FIG. 8 is a perspective view of an antenna device including a dual frequency band radiator array according to an embodiment of the present disclosure, and FIG. 9 is a top view of an antenna device including a dual frequency band radiator array in FIG. 8. Hereinafter, an antenna device 2000 including the dual frequency band radiator array according to an embodiment of the present disclosure will be described in more detail with reference to FIGS. 8 to 9.

In this regard, the antenna device 2000 according to an embodiment of the present disclosure may be implemented as, for example, a stacked radiator module, but the present disclosure may not be limited thereto. When implemented in the stacked type, it may be manufactured using various processes and materials such as a PCB, an LTCC, and a glass using, for example, two-dimensional stacking technology. For example, the entire radiator module may be implemented to have a height of 0.1λ (based on 24 GHz), and a ground signal ground (GSG) pad in a coaxial method may be set on a top surface to enable easy surface mount of a communication chip. The GSG pad may be connected to a signal supply path via a vertical interconnection. A current may be transmitted via the signal supply path in a frequency-selective manner, and the corresponding current may feed the antenna in a form of a vertical probe.

When the antenna device 2000 in the stacked type is implemented according to an aspect, for example, the antenna device 2000 may be implemented based on an LTCC process. For example, it may be formed of a total of 12 metal layers (Ag 10 um) and 11 layers of dielectric (LTCC 0.1 mm) layers. LTCC may have a dielectric constant of 5.9 and a loss tangent of 0.002, but the present disclosure may not be limited thereto. Metal L1 to L5 structures may be used for a feed structure, and in a remaining area, for example, L12 may be used as a space for implementation of the radiator. In other words, the antenna device 2000 according to an aspect may be in the stacked structure including a plurality of layers, and for example, as illustrated in FIGS. 1 to 2 and 8, the radiator may be implemented in the single layer such as, for example, L12. Accordingly, the antenna device 2000 according to an embodiment of the present disclosure may implement the antenna device capable of beamforming for the dual-harmonic frequencies based on the single layer.

As illustrated in FIGS. 8 to 9, the antenna device 2000 including the dual frequency band radiator array according to an embodiment of the present disclosure may include a radiator array including a plurality of radiator modules 1000-1, 1000-2, 1000-3, 1000-4, 1000-5, 1000-6, and 1000-7, and a control circuit (not shown) that applies signals to the plurality of radiator modules 1000-1, 1000-2, 1000-3, 1000-4, 1000-5, 1000-6, and 1000-7.

Here, each of the plurality of radiator modules 1000-1, 1000-2, 1000-3, 1000-4, 1000-5, 1000-6, and 1000-7 may include the ground layer 100, the circular patch radiator 300, the via-wall 200, and the port 400, as described above with reference to FIGS. 1 to 2.

Here, the control circuit may perform both beamforming for the signal in the first frequency band and beamforming for the signal in the second frequency band by supplying a feeding signal to at least some of the plurality of radiator modules 1000-1, 1000-2, 1000-3, 1000-4, 1000-5, 1000-6, and 1000-7.

In a non-limiting yet more detailed manner, as illustrated in FIGS. 1 and 2, in each of the plurality of radiator modules 1000-1, 1000-2, 1000-3, 1000-4, 1000-5, 1000-6, and 1000-7, the ground layer 100 may be disposed, and the circular patch radiator 300 may be disposed on the ground layer 100 so as to be spaced apart from the ground layer 100 by the predetermined length. From the ground layer 100 to at least a portion of the area (e.g., the circular area) surrounding the circular patch radiator 300, the plurality of vertical probes 210 may extend to constitute the via-wall 200. The port 400 may be disposed between the ground layer 100 and the circular patch radiator 300 and provide the electrical connection between the ground layer 100 and the circular patch radiator 300. According to an aspect, each of the plurality of radiator modules 1000-1, 1000-2, 1000-3, 1000-4, 1000-5, 1000-6, and 1000-7 may radiate the signal in the first frequency band based on the via-wall 200 and radiate the signal in the second frequency band different from the first frequency band based on the via-wall 200 and the circular patch radiator 300.

Here, each of the plurality of radiator modules 1000-1, 1000-2, 1000-3, 1000-4, 1000-5, 1000-6, and 1000-7 may include at least some of the technical features described above in connection with the dual frequency band radiator module 1000 according to an embodiment of the present disclosure, but the present disclosure may not be limited thereto.

As illustrated in FIGS. 8 to 9, according to an aspect of the present disclosure, the antenna device 2000 may include a plurality of feeding ports, the number of which is smaller than the number of plurality of radiator modules. In the example of FIGS. 8 to 9, it is illustrated that seven radiator modules 1000-1, 1000-2, 1000-3, 1000-4, 1000-5, 1000-6, and 1000-7 and four feeding ports 800-1, 800-2, 800-3, and 800-4 are disposed, but the technical idea of the present disclosure is not limited thereto. According to an aspect, at least some of the plurality of feeding ports 800-1, 800-2, 800-3, and 800-4 may supply the feeding signal to the plurality of radiator modules, and the others of the plurality of feeding ports 800-1, 800-2, 800-3, and 800-4 may supply the feeding signal to only one radiator module.

According to an aspect, the plurality of radiator modules may be arranged at an array spacing for performing beamforming on the signal in the second frequency band. That is, as a non-limiting example, as illustrated in FIGS. 8 to 9, the antenna device 2000 may include the seven radiator modules arranged at a spacing of 3.1 mm and the four feeding ports as the phased array antenna. In this regard, different types of feed structures may be coupled to the feeding ports. Accordingly, for example, when the first frequency is 24 GHz, the radiator modules for the first frequency may have a spacing of 6.2 mm, and when the second frequency is 48 GHz, the radiator modules for the second frequency may have a spacing of 3.1 mm.

Hereinafter, for convenience of description, the first radiator module 1000-1 to the seventh radiator module 1000-7 and the first feeding port 800-1 to the fourth feeding port 800-4 may be described as the example, but it is noted that the technical idea of the present disclosure is not limited thereto. That is, it should be understood that a configuration including a different number of radiator modules and/or feeding ports from that illustrated in the drawings is also included in the technical scope of the present disclosure.

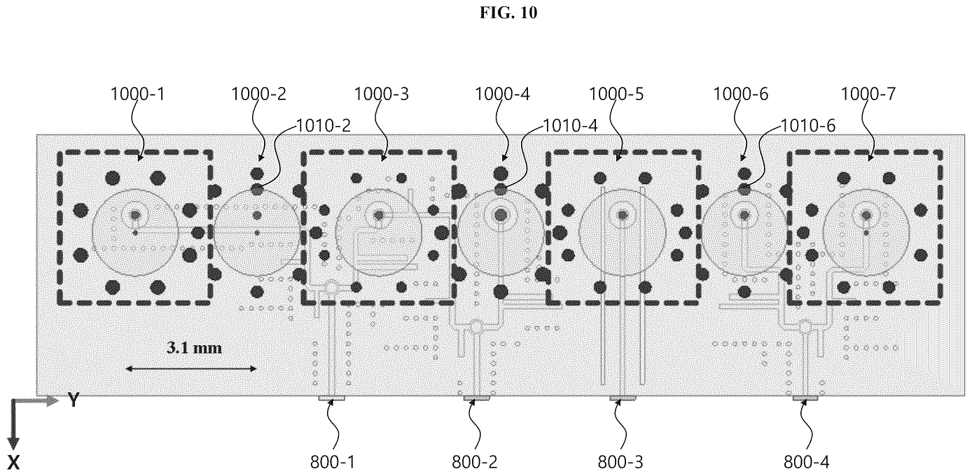

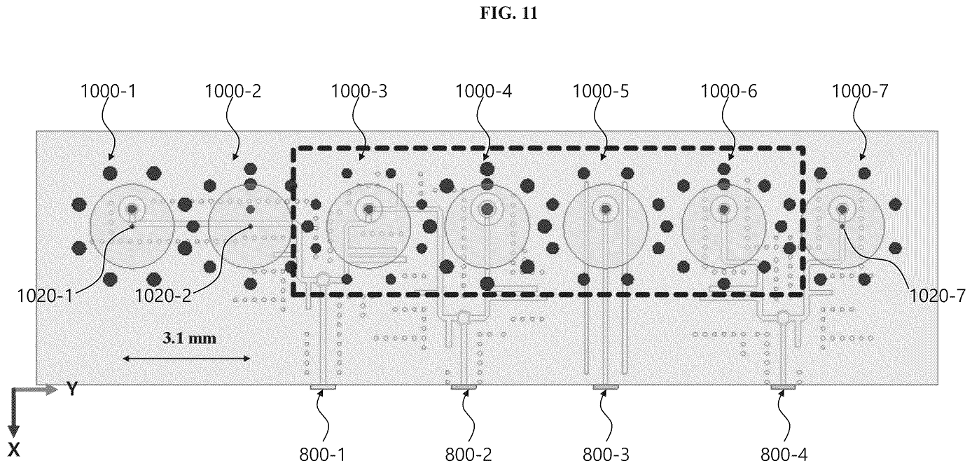

FIG. 10 illustrates a radiator module that radiates a signal in a first frequency band in an antenna device in FIG. 8, and FIG. 11 illustrates a radiator module that radiates a signal in a second frequency band in an antenna device in FIG. 8. As illustrated in FIGS. 8 to 11, in the antenna device 2000 according to an embodiment of the present disclosure, at least some of the plurality of radiator modules 1000-1, 1000-2, 1000-3, 1000-4, 1000-5, 1000-6, and 1000-7 may be used to implement the signal radiation in the first frequency band and beamforming for the signal in the first frequency band, and at least some of the plurality of radiator modules 1000-1, 1000-2, 1000-3, 1000-4, 1000-5, 1000-6, and 1000-7 may be used to implement the signal radiation in the second frequency band and beamforming for the signal in the second frequency band.

Here, according to an aspect, at least some of the plurality of radiator modules may be used to radiate the signal in the first frequency band and the signal in the second frequency band. For example, the third radiator module 1000-3 and/or the fifth radiator module 1000-5 may be used to radiate the signal in the first frequency band and may also be used to radiate the signal in the second frequency band.

On the other hand, according to an aspect, at least some of the plurality of radiator modules 1000-1, 1000-2, 1000-3, 1000-4, 1000-5, 1000-6, and 1000-7 may not radiate any of the signal in the first frequency band and the signal in the second frequency band. For example, the second radiator module 1000-2 may not be used to radiate the signal in the first frequency band, and may also not be used to radiate the signal in the second frequency band. Such a second radiator module 1000-2 may be used for impedance matching of other radiator modules, for example, and may be disposed for process convenience or utilization for other frequency bands.

In one example, as described above, the antenna device 2000 according to an embodiment of the present disclosure may include the plurality of feeding ports 800-1, 800-2, 800-3, and 800-4, at least some of the feeding ports may supply signals to one radiator module, and at least some of the feeding ports may supply signals to two or more radiator modules. For example, the first feeding port 800-1 may supply feed signals to the first radiator module 1000-1 and the third radiator module 1000-3, and the second feeding port 800-2 may supply the feed signals to the third radiator module 1000-3 and the fourth radiator module 1000-4. On the other hand, the third feeding port 800-3 may supply the feed signal only to the fifth radiator module 1000-5. On the other hand, the fourth feeding port 800-4 may supply the feeding signal to the sixth radiator module 1000-6 and the seventh radiator module 1000-7. However, it should be noted that such a signal supply path is merely an example, and the technical idea of the present disclosure is not limited thereto.

In the plurality of radiator modules 1000-1, 1000-2, 1000-3, 1000-4, 1000-5, 1000-6, and 1000-7 illustrated in FIG. 9, the feeding ports and radiation frequency bands are exemplarily described.

As a non-limiting example, the first radiator module 1000-1 may radiate the signal in the first frequency band based on the feed signal from the first feeding port, and the third radiator module 1000-3 may radiate the signal in the second frequency band based on the feed signal from the first feeding port or radiate the signal in the first frequency band based on the feed signal from the second feeding port.

The fourth radiator module 1000-4 may radiate the signal in the second frequency band based on the feed signal from the second feeding port, and the fifth radiator module 1000-5 may radiate the signal in the first frequency band based on the feed signal from the third feeding port or radiate the signal in the second frequency band based on the feed signal from the third feeding port.

The sixth radiator module 1000-6 may radiate the signal in the second frequency band based on the feed signal from the fourth feeding port, and the seventh radiator module 1000-7 may radiate the signal in the first frequency band based on the feed signal from the fourth feeding port.

However, it should be noted that the feeding ports and the radiation frequency bands of the radiator modules as such are merely exemplary, and the technical idea of the present disclosure is not limited thereto.

According to an aspect of the present disclosure, the control circuit of the antenna device 2000 may perform beamforming on the signal in the first frequency band based on two radiator modules disposed at outermost sides of the radiator array, and at least some radiator modules that are not consecutively arranged among radiator modules excluding the radiator modules disposed at the outermost sides of the radiator array, among the plurality of radiator modules.

As a non-limiting example, as illustrated in FIG. 10, the first radiator module 1000-1 and the seventh radiator module 1000-7, which are the two radiator modules disposed at the outermost sides of the radiator array, and the third radiator module 1000-3 and the fifth radiator module 1000-5, which are the at least some radiator modules that are not consecutively arranged among the radiator modules excluding the radiator modules disposed at the outermost sides of the radiator array, may be used for the signal radiation and beamforming in the first frequency band (e.g., 24 GHz).

In one example, according to an aspect of the present disclosure, the control circuit of the antenna device 2000 may perform beamforming on the signal in the second frequency band based on at least some radiator modules consecutively arranged among the radiator modules excluding the radiator modules disposed at the outermost sides of the radiator array, among the plurality of radiator modules.

As a non-limiting example, as illustrated in FIG. 11, the third radiator module 1000-3 to the sixth radiator module 1000-6, which are the at least some radiator modules consecutively arranged among the radiator modules excluding the radiator modules disposed at the outermost sides of the radiator array, may be used for the signal radiation and beamforming in the second frequency band (e.g., 48 GHz).

In one example, according to an aspect of the present disclosure, at least some of the plurality of radiator modules 1000-1, 1000-2, 1000-3, 1000-4, 1000-5, 1000-6, and 1000-7 may have a configuration for signal isolation between the radiator modules via impedance mismatching.

As a non-limiting example, according to an aspect of the present disclosure, at least some of the radiator modules that are not used to radiate the signal in the first frequency band among the plurality of radiator modules may further include a first shorting pin that connects the ground layer 100 with the circular patch radiator 300 in a null area based on an electric field distribution associated with the signal radiation in the second frequency band.

The radiator modules that are not used to radiate the signal in the first frequency band may include the radiator module that is used only for the signal radiation in the second frequency band, such as, for example, the fourth radiator module 1000-4 or the sixth radiator module 1000-6. In addition, the radiator modules that are not used to radiate the signal in the first frequency band may further include the radiator module that is not used as the radiator, such as, for example, the second radiator module 1000-2. In this regard, according to an aspect, at least one of the second radiator module 1000-2, the fourth radiator module 1000-4, and the sixth radiator module 1000-6 may include a corresponding first shorting pin 1010-2, 1010-4, or 1010-6 that connects the ground layer 100 with the circular patch radiator 300 in the null area based on the electric field distribution associated with the signal radiation in the second frequency band.

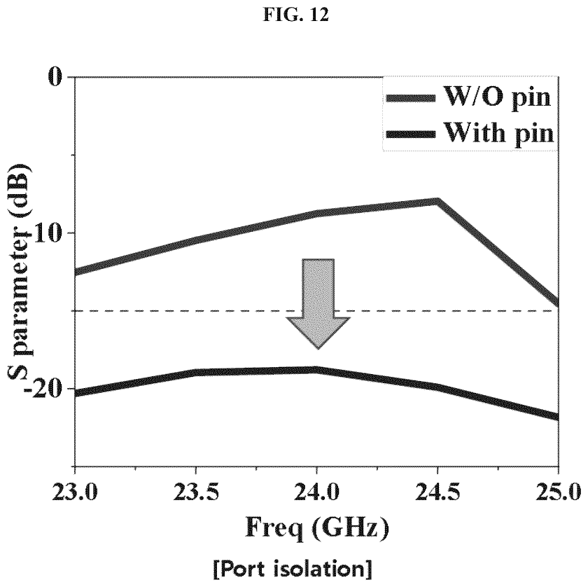

According to an aspect, the first shorting pin may cause the impedance mismatching with respect to the signal in the first frequency band and not have an influence on the signal in the second frequency band. In this regard, FIG. 12 illustrates an improvement in a radiation performance of a signal in a first frequency band based on a presence of a first shorting pin. That is, as illustrated in FIG. 12, the first shorting pin may increase isolation between the ports in the first frequency band.

As a non-limiting example, according to an aspect of the present disclosure, at least some of the radiator modules that are not used to radiate the signal in the second frequency band among the plurality of radiator modules may further include the second shorting pin that connects the ground layer 100 with the circular patch radiator 300 in a null area based on the electric field distribution associated with the signal radiation in the first frequency band.

The radiator modules not used to radiate the signal in the second frequency band may include the radiator module used only for the signal radiation in the first frequency band, such as, for example, the first radiator module 1000-1 or the seventh radiator module 1000-7. In addition, the radiator modules not used to radiate the signal in the first frequency band may further include the radiator module that is not used as the radiator, such as, for example, the second radiator module 1000-2. In this regard, according to an aspect, at least one of the first radiator module 1000-1, the second radiator module 1000-2, and the seventh radiator module 1000-7 may include a corresponding second shorting pin 1020-1, 1020-2, or 1020-7 that connects the ground layer 100 with the circular patch radiator 300 in the null area based on the electric field distribution associated with the signal radiation in the first frequency band.

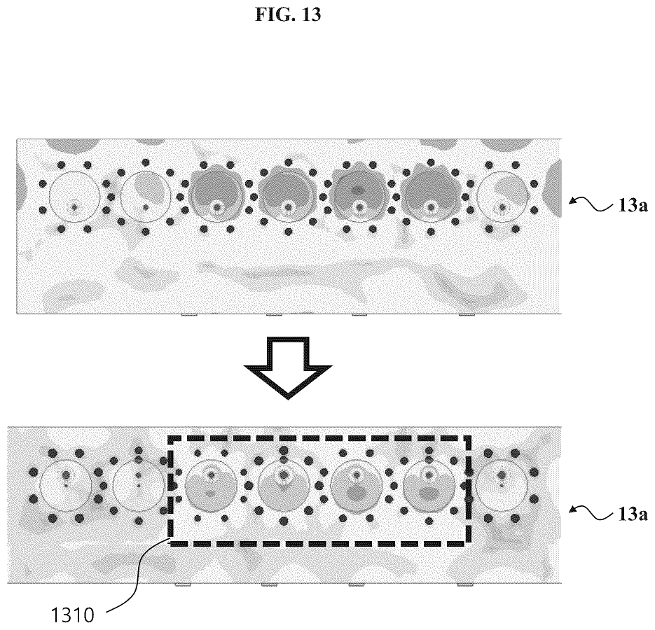

According to an aspect, the second shorting pin may cause impedance mismatching with respect to the signal in the second frequency band and not have an influence on the signal in the first frequency band. In this regard, FIG. 13 illustrates an improvement in a radiation performance of a signal in a second frequency band based on a presence of a shorting pin. That is, as illustrated in FIG. 13, the second shorting pin may have an effect of reducing a size of the ground 1310 by preventing an electric field from propagating to the corresponding area.

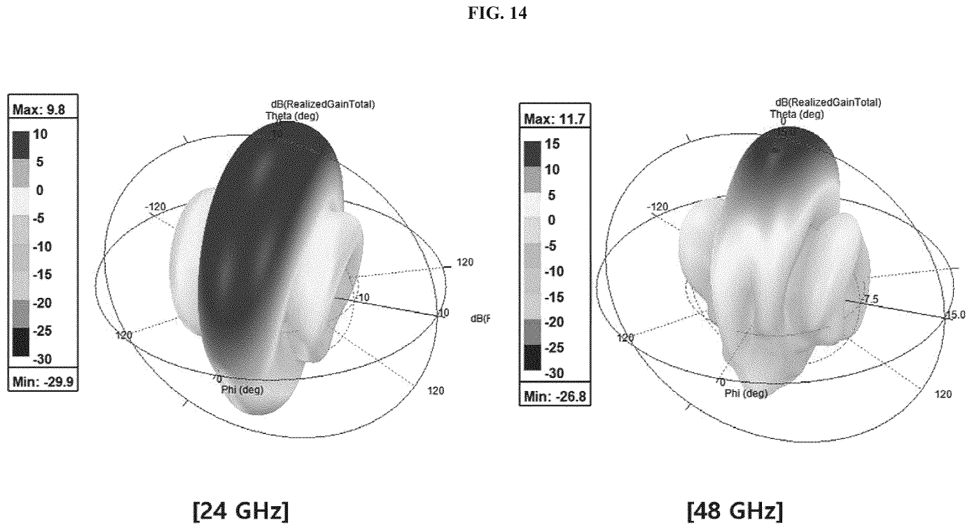

FIG. 14 illustrates radiation patterns in a first frequency band and a second frequency band based on an antenna device including a dual frequency band radiator array according to an embodiment of the present disclosure. As illustrated in FIG. 14, based on the antenna device 2000 according to an embodiment of the present disclosure, it may be seen that the broadside radiation is simultaneously implemented in the first frequency (e.g., 24 GHz) band and the second frequency (e.g., 48 GHz) band using only the single layer. Realized gains of 9.8 dBi and 11.7 dBi were respectively measured in the first frequency (e.g., 24 GHz) band and in the second frequency (e.g., 48 GHz) band.

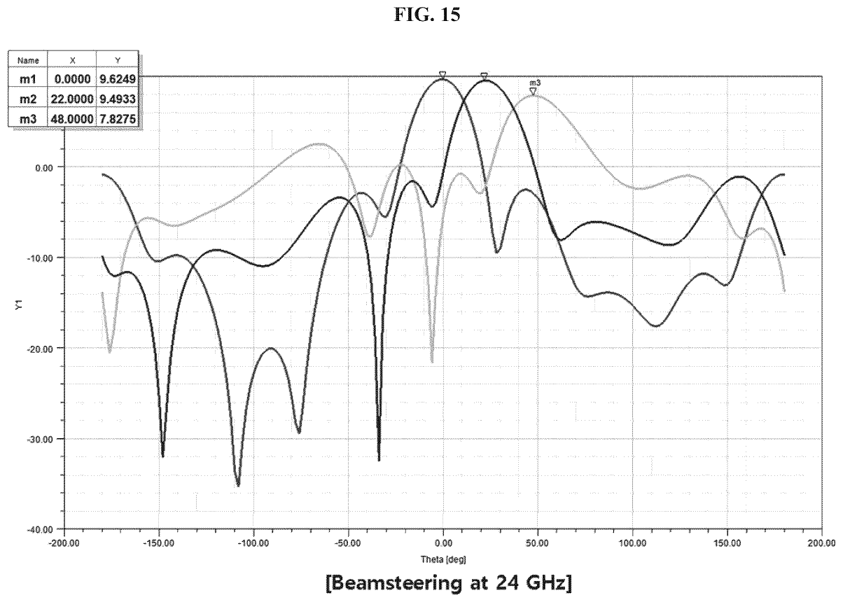

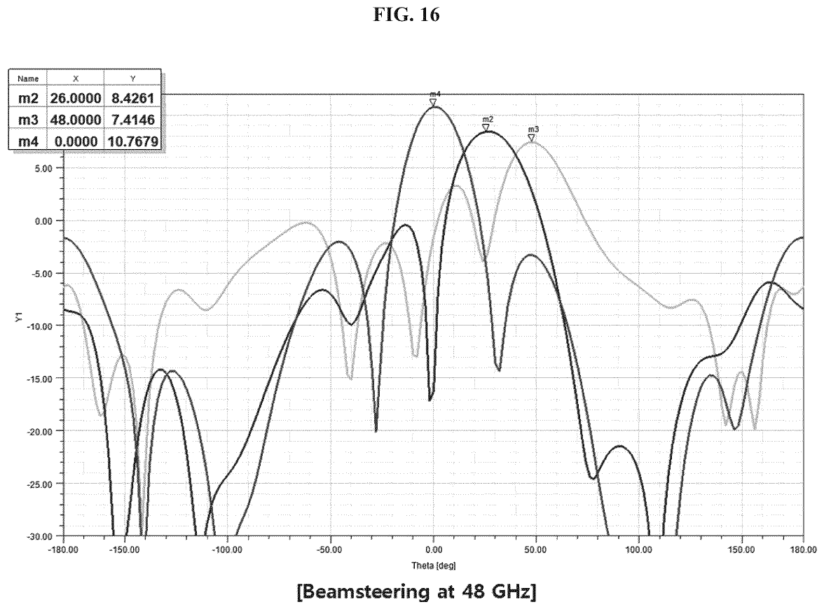

FIG. 15 illustrates a beamforming performance at a first frequency based on an antenna device including a dual frequency band radiator array according to an embodiment of the present disclosure, and FIG. 16 illustrates a beamforming performance at a second frequency based on an antenna device including a dual frequency band radiator array according to an embodiment of the present disclosure. As illustrated in FIGS. 15 to 16, in the antenna device 2000 including the dual frequency band radiator array according to an embodiment of the present disclosure, beam steering in a range of −50 deg to 50 deg was identified in both the 24 GHz and 48 GHz frequency bands.

Although the description has been made with reference to the drawings and the embodiments, it should be understood that the scope of the present disclosure is not limited thereto. Those skilled in the art will appreciate that various modifications and changes may be made to the present disclosure without departing from the spirit and scope of the present disclosure as defined in the following claims.

The present disclosure has been described based on a series of functional blocks, but is not limited to the above-described embodiments and the accompanying drawings, and it will be obvious to a person skilled in the art to which the present disclosure belongs that various substitutions, modifications, and changes may be made within the scope not departing from the technical spirit of the present disclosure.

Combinations of the above-described embodiments are not limited to the above-described embodiments, and various types of combinations as well as the above-described embodiments may be provided based on implementation and/or necessity.

In the above-described embodiments, the methods have been described based on a flowchart as a series of steps or blocks, but the present disclosure may not be limited to an order of the steps, and some steps may occur in a different order or simultaneously with other steps as described above. In addition, those of ordinary skill in the art will appreciate that the steps illustrated in the flowchart are not exclusive, other steps may be included, or one or more steps in the flowchart may be deleted without affecting the scope of the present disclosure.

The foregoing embodiment includes examples of various aspects. While all possible combinations for representing the various aspects are not able to be described, those of ordinary skill in the art will be able to recognize that other combinations are available. Accordingly, the present disclosure will be said to include all other replacements, modifications, and changes that fall within the scope of the following claims.

What is claimed is:

1. A dual frequency band radiator module comprising:
a ground layer;
a circular patch radiator disposed on the ground layer so as to be spaced apart from the ground layer by a predetermined length;
a via-wall composed of a plurality of vertical probes extending from the ground layer to an area surrounding the circular patch radiator; and
a port disposed between the ground layer and the circular patch radiator,
wherein a signal in a first frequency band is radiated based on the via-wall,
wherein a signal in a second frequency band different from the first frequency band is radiated based on the via-wall and the circular patch radiator.

2. The dual frequency band radiator module of claim 1, wherein the first frequency band covers a first frequency,
wherein the second frequency band covers a second frequency, wherein the second frequency is n times the first frequency, and n is a natural number equal to or greater than 2.

3. The dual frequency band radiator module of claim 1, wherein the signal in the first frequency band is radiated via resonance in a first mode of the via-wall.

4. The dual frequency band radiator module of claim 3, wherein the first mode resonance of the via-wall radiates a signal in a frequency band lower than a frequency band of a signal radiated based on resonance in a first mode of the circular patch radiator.

5. The dual frequency band radiator module of claim 4, wherein the via-wall forms a perfect magnetic conductor (PMC) boundary different from a state of the circular patch radiator disposed without the via-wall.

6. The dual frequency band radiator module of claim 3, wherein a signal via resonance in a second mode of the via-wall and a signal via resonance in a third mode of the circular patch radiator are synthesized to radiate the signal in the second frequency band.

7. The dual frequency band radiator module of claim 6, wherein at least a portion of current flows formed by the via-wall and at least a portion of current flows formed by the circular patch radiator cancel each other.

8. The dual frequency band radiator module of claim 7, wherein at least the portion of the current flows formed by the circular patch radiator forms residual current flows, and the signal in the second frequency band is radiated by the residual current flows.

9. The dual frequency band radiator module of claim 6, wherein the first mode is a TM11 mode,
wherein the second mode is a TM12 mode,
wherein the third mode is a TM10 mode.

10. The dual frequency band radiator module of claim 4, wherein a first frequency is 24 GHz,
wherein a second frequency is 48 GHz.

11. An antenna device including a dual frequency band radiator array, wherein the antenna device comprising:
the radiator array including a plurality of radiator modules; and
a control circuit configured to apply signals to the plurality of radiator modules,
wherein each of the plurality of radiator modules includes:
a ground layer;
a circular patch radiator disposed on the ground layer so as to be spaced apart from the ground layer by a predetermined length;
a via-wall composed of a plurality of vertical probes extending from the ground layer to an area surrounding the circular patch radiator; and
a port disposed between the ground layer and the circular patch radiator,
wherein a signal in a first frequency band is radiated based on the via-wall,
wherein a signal in a second frequency band different from the first frequency band is radiated based on the via-wall and the circular patch radiator,
wherein the control circuit is configured to perform beamforming for the signal in the first frequency band and beamforming for the signal in the second frequency band.

12. The antenna device of claim 11, wherein the plurality of radiator modules are arranged at an array spacing for performing beamforming for the signal in the second frequency band.

13. The antenna device of claim 11, wherein the control circuit is configured to perform beamforming for the signal in the second frequency band based on at least some radiator modules consecutively arranged among radiator modules excluding radiator modules disposed at outermost sides of the radiator array, among the plurality of radiator modules.

14. The antenna device of claim 11, wherein the control circuit is configured to perform beamforming for the signal in the first frequency band based on two radiator modules disposed at outermost sides of the radiator array, and at least some radiator modules not consecutively arranged among radiator modules excluding the radiator modules disposed at the outermost sides of the radiator array, among the plurality of radiator modules.

15. The antenna device of claim 11, wherein at least some of radiator modules not used to radiate the signal in the first frequency band among the plurality of radiator modules further include a first shorting pin connecting the ground layer with the circular patch radiator in a null area based on an electric field distribution associated with the signal radiation in the second frequency band.

16. The antenna device of claim 15, wherein the first shorting pin is configured to:
cause impedance mismatching on the signal in the first frequency band; and
not have an influence on the signal in the second frequency band.

17. The antenna device of claim 11, wherein at least some of radiator modules not used to radiate the signal in the second frequency band among the plurality of radiator modules further include a second shorting pin connecting the ground layer with the circular patch radiator in a null area based on an electric field distribution associated with the signal radiation in the first frequency band.

18. The antenna device of claim 17, wherein the second shorting pin is configured to:
cause impedance mismatching on the signal in the second frequency band; and
not have an influence on the signal in the first frequency band.

19. The antenna device of claim 11, further comprising a plurality of feeding ports, wherein the number of feeding ports is smaller than the number of plurality of radiator modules.

20. The antenna device of claim 19, wherein at least some of the plurality of feeding ports are configured to supply feed signals to multiple radiator modules,
wherein others of the plurality of feeding ports are configured to supply the feed signal to only one radiator module.
